(19) United States
(12) Patent Application Publication
(10) Pub. No.: US 2026/0367240 A1
(43) Pub. Date: Nov. 19, 2026

(54) METHOD AND SYSTEM FOR RESOLVING RANGE AND VELOCITY FROM AT LEAST ONE OBJECT

(71) Applicant: Radar Reticence AB, Harplinge (SE)

(72) Inventors: Emil Nilsson, Harplinge (SE); Hans Hellsten, Linköping (SE)

(21) Appl. No.: 19/153,809

(22) PCT Filed: Feb. 5, 2024
(86) PCT No.: PCT/EP2024/052690

§ 371 Date: Aug. 5, 2025

(30) Foreign Application Priority Data
Feb. 15, 2023 (SE) 2350147-1

(51) Int. Cl. G01S 13/58; G01S 13/32

(52) U.S. Cl. CPC G01S 13/584; G01S 13/32

(57) ABSTRACT

A method for resolving range and velocity from at least one object, the method including transmitting sweep pairs. Further, the method includes obtaining, independently, a first and a second time domain signal formed by reflections of the first and second electromagnetic waveforms of the sweep pair and determining a beat frequency for a baseband signal of each obtained time-domain signal in the sweep pair. Further, the method includes determining a velocity and a range of the at least one object by linearly combining, beat frequencies of the obtained first and second signals of the sweep pair so to derive the velocity and range of the single object. However, if the obtained signals are reflected from a plurality of objects, the step of determining includes linearly combining the beat frequencies obtained from the signals to derive a plurality of possible associations. The method includes transmitting a sequence of further sweep pairs.

### TECHNICAL FIELD

The present disclosure relates to a method and a system for resolving range and velocity from at least one object.

### BACKGROUND

Today vehicles are equipped with radar devices typically focused to specific directions e.g. in the heading direction of the vehicle. The radar devices are required to operate within predefined frequency bands with each radar occupying a significant part of this band. Since conventional radar devices are prone to be blinded by interference in its operating band, the availability of the allotted band would be a highly partial even in moderately congested traffic situations.

Accordingly, vehicles with radar devices, specifically in areas having a moderate to high quantity of vehicles, are subject to interference. Presently, there are no suitable methods, systems and radar devices that are able to effectively mitigate this risk of interference, unless by impairing on fundamental radar performance characteristics such as uninterrupted availability of radar, multiple target capability, range coverage, speed and velocity resolution.

Previous technology may work only as long as maintaining radar performance is not paramount to vehicle safety. However, with the current increasing dependence on vehicle sensors, and in particular with the advent of self-driving cars, maintained radar performance becomes an absolute requirement.

In short, there is room for methods, radar devices and systems in the existing art to be improved to meet the demands for interference mitigation now arising in road traffic.

### SUMMARY

It is therefore an object of the present disclosure to provide such new methods, systems and electronic devices that mitigate interference when resolving range and velocity of objects. At the same time allowing for many users in a frequency band without any performance degradation.

The basis of non-interference between radars in the same band is that the radars adopt linear sweep radar signals with the same sweep rate. The signals thus differ by being launched at different times and will thus never simultaneously operate at the same frequency. In some aspects, to provide a sufficient level of non interference, specific long sweep times may be provided as suggested by the present disclosure, making the signal travel time between potentially interfering radars small by comparison. Also signal start/end effects may cause interference but will be sufficiently far between. For a linear sweep radar, target range and velocity can be measured by the so-called beat frequency of the radar response, with the beat frequency being a linear combination of the range and velocity of a target. Since beat frequency is a single value, neither range nor velocity values follows uniquely. In some aspects a sequence of sweeps may be adopted, where velocity causes a phase shift between these sweeps. From the phase shift target Doppler frequency and thus velocity is computed. With velocity resolved, range follows unambiguously.

However, the slow sweep rate required for interference avoidance is several magnitudes lower than the repetition rate required for phase measurement and thus Doppler determination. By consequence a different method is required for resolving this range-velocity ambiguity. As will become apparent in the following, this objective is achieved by an electronic device, system and a method as defined in the appended claims.

The present disclosure relates to a (computer-implemented) method for resolving range and velocity from at least one object, the method comprising the steps of transmitting, simultaneously, a first and a second electromagnetic waveform, each comprising a frequency modulated (preferably linear) chirp having a pre-determined sweep time, the first and second electromagnetic waveforms being counter directed chirps forming what will be referred to as a sweep pair. The method further comprises the step of obtaining, independently, a first and a second time domain signal, formed by reflections of said first and second electromagnetic waveforms of said sweep pair. The sweep pair may have been reflected off one or more object—typically vehicles or other objects along a road.

The method further comprises detecting/determining beat frequencies in the baseband signal of each obtained time-domain signal in said sweep pair and determining a velocity and range of said at least one object. If said obtained signals are reflected from a single object, the step of determining comprises linearly combining, beat frequencies of the obtained first and second signals of the sweep pair so to derive the velocity and range of said single object. Thus, based on the beat frequency values in the two bands, an arising linear equation system may be solved to determine velocity and range of said at least one object.

Moreover, if said obtained signals are reflected from a plurality of objects, the step of determining target velocity and range (values) comprises linearly combining the beat frequencies obtained from the signals to derive a plurality of possible associations. In other words, the method comprises associating any one beat frequency from one of the bands with any one beat frequency from the other band, and by solving a thereby defined linear equation systems to derive a plurality of range velocity pairs. for P targets, the associations and thus velocity-range pairs are P², P being an integer >0, while each association representing/being indicative of a possible target. Whilst P may refer to the number of actual objects/targets the P² associations are indicative of a target, amongst which P²−P associations are likely to be false. To remove these, the method further comprises transmitting a (continuous) sequence of further sweep pairs. Within this sequence, beat frequencies will change, corresponding to that object ranges change following the inherent velocity of each object. Again, associating these changing beat frequencies, it is possible to compute not only the changing range but also the target range at the time of the first sweep.

The computed range value remains constant from one sweep to the next if the association is correct. Similarly, the velocity values computed only remain constant for a correct association. Thus, neglecting associations which cause range and velocity to shift in course of continued sweeps, the correct associations are found. Note that the measurements entail establishing beat frequency shifts, rather than phase shifts. Hence, frequency measurements are not sensitive to sampling rate, as are phase measurements, and sweeps can occur at the slow rate consistent with interference mitigation. In all, the method efficiently allows for correctly establishing the range and velocity of one or several objects.

The method may, in the step of determining or prior to the step of determining, comprise the step of determining whether said obtained signals are reflected from a single object or from a plurality of objects. This may be performed in a variety of ways as may be appreciated by a skilled person.

In some aspects herein, at a centre frequency of 50-90 GHz, said pre-determined sweep time is 2-3 milliseconds, preferably, 2.25-2.75 milliseconds, more preferably 2.5 milliseconds. With this selection, and keeping to standard performance figures of present day radar, a large amount of non-interfering radar devices (about 1000) may occupy the band.

Moreover, in some aspects herein, each first electromagnetic waveform is in a first frequency channel, and each second electromagnetic waveform is in a second frequency channel, wherein the first and the second frequency channel are adjacent each other.

Further, in some aspects herein the method comprises the step of identifying; calculating, by signal processing, a difference between range values obtained from associations in a sweep pair sequence counted in positive time direction and corresponding associations in a sweep pair sequence counted in negative time direction from an arbitrarily selected zero time.

Including both cases that a target is moving at constant velocity or undergoes a velocity change, the range differences have zero mean only if the association is correct. The step of removing false associations therefore comprises rejecting amongst said associations, those for which range differences estimates based on multiple sweeps are non-zero. The advantage of accepting velocity changes makes the method valid in the important applications of cars, accelerating or retarding, including situations where cars may emergency break.

This method may be performed by a computer algorithm, matching the range differences obtained from each sweep to a model of linear progression since false associations also follows such a path of linear progression, albeit with the range differences increasing at a non-zero rate. With each measurement, randomized by noise and measurement errors, false associations are removed as the progress rate (estimated with increasing accuracy from an ongoing measurement) is above what is to be expected for the range differences of the correct associations, which all fluctuates around a zero mean. Proceeding in this way grossly false association can be removed within the first few sweeps, whereas as target separation eventually grows smaller than radar resolution, a limit to resolvability of false associations is reached.

Further, index sweep number by [symbol] =0,1, . . . with the first sweep [symbol] =0 at some arbitrarily selected time. Denote upper and lower band beat frequencies

$${F}_{m ( ℓ )}^{ℓ -} , {F}_{n ( ℓ )}^{ℓ +} ; m ( ℓ ) , n ( ℓ ) = 1 , 2 ,$$

where m=1, . . . , P; n=1, . . . , P and

$${F}_{m}^{ℓ -} , {F}_{n}^{ℓ +}$$

ordered in increasing frequency values, whereas [symbol] , [symbol] are the tracked beat frequencies, allowing for that there can be an interchange of any of frequency numbers m or n if beat frequencies cross each other from one sweep to the next (as may happen in congested situations of very many targets moving at different speeds). Range values from any combination of beat frequencies, thus representing true or false targets are obtained as

$${r}_{n ( ℓ ) m ( ℓ )}^{ℓ} = \frac{c τ}{2 B} [ {F}_{m ( ℓ )}^{ℓ -} ( 1 + \frac{B}{4 {f}_{c}} ) - {F}_{n ( ℓ )}^{ℓ +} ( 1 - \frac{B}{4 {f}_{c}} ) ] \qquad ( 1 )$$

with c speed of light, B bandwidth, f_{c} center frequency, and τ sweep time for a single sweep. Range differences computed as

$${ρ}_{n ( ℓ ) m ( ℓ )}^{ℓ} = {r}_{n ( ℓ + 1 ) m ( ℓ + 1 )}^{ℓ + 1} - {r}_{n ( ℓ ) m ( ℓ )}^{- ℓ}$$

behave according to

$${ρ}_{n ( ℓ ) m ( ℓ )}^{ℓ} = ( ℓ + \frac{1}{2} ) \frac{B}{4 {f}_{c}} Δ r$$

where Δr is the separation of the targets associated, i.e.

$$Δ r = 0 ⇒ {ρ}_{n ( ℓ ) m ( ℓ )}^{ℓ} = 0$$

for a true association. Typically, B/(4fₑ)=4% whilst

$${ρ}_{n ( ℓ ) m ( ℓ )}^{ℓ}$$

can be established equal to or better than radar resolution—say within 0.1 m as an example. It then follows that false associations can be rejected for targets more than Δr=1 m apart within 28 sweeps i.e. τ×28=0.07 s total registration time, with sweep time τ=2.5 ms given above.

Further to the method, here is also provided a computer-accessible storage medium storing one or more programs configured to be executed by one or more control circuitry of a vehicle, the one or more programs including instructions for performing the method of any aspect herein.

There is also provided an electronic device comprising control circuitry. The electronic device may comprise modules for performing the method herein. The control circuitry of the electronic device may comprise an oscillator, at least one mixer, up/down-conversion modules, an analog to digital converter, a digital to analog converter, fast Fourier transform modules, amplifiers, filters and other suitable circuitry. The electronic device further comprises at least one transmitter and receiver coupled to respective transmitting and receiving antenna arrays each array having a plurality of antenna elements. The electronic device may be referred to as a radar device.

Further, there is provided a vehicle comprising said electronic device having control circuitry therein configured to perform the method according to any aspect herein. The vehicle may be a land vehicle, an airborne vehicle, spaceborne or a ship. There is also provided a fixed installation comprising said electronic device having control circuitry therein configured to perform the method according to any aspect herein. The fixed installation may be a base station.

In some aspects of the method, there is provided a system comprising a plurality of similar electronic devices (i.e. radar devices) performing the method according to any one of the aspects herein, wherein each electronic device utilizes one of a plurality transmission channels for transmitting said counter directed chirps, wherein adjacent channels of said plurality transmission channels have a time delay relative each other. The time delay may be e.g. 2-4 μs or any other suitable value. The amount of channels may be varied from 10, to 100 or 1000 channels or even more than 1000 channels.

Generally, all terms used in the description are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise.

### BRIEF DESCRIPTION OF THE DRAWINGS

These and other features and advantages of the present disclosure will now be further clarified and described in more detail, with reference to the appended drawings;

FIG. 1 schematically illustrates a method in the form of a flowchart;

FIG. 2A illustrates a graph depicting a sweep pair;

FIG. 2B illustrates a graph depicting linear combination of beat frequencies;

FIG. 3 illustrates a graph depicting linear combinations of beat frequencies for a plurality of possible associations;

FIG. 4 schematically illustrates an electronic device;

FIG. 5A schematically illustrates a system;

FIG. 5B schematically illustrates a plurality of radar devices utilizing the same band;

FIG. 6 illustrates four plots simulating results of aspects of the disclosure herein;

### DETAILED DESCRIPTION

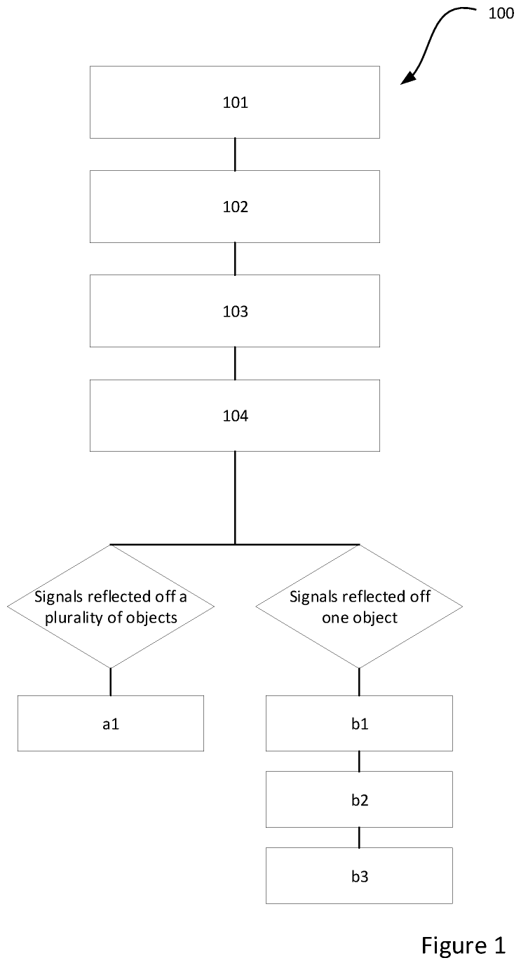

FIG. 1 schematically in the form of a flowchart illustrates a method 100 for resolving range and velocity from at least one object, the method comprising the steps of transmitting 101, simultaneously, a first and a second electromagnetic waveform. Each comprising a frequency modulated chirp having a pre-determined sweep time, the first and second electromagnetic waveforms being counter directed chirps forming a sweep pair. Further, the method 100 comprises the step of obtaining 102, independently, a first and a second signal formed by reflections of said first and second electromagnetic waveforms of said sweep pair. Moreover, the method 100 comprises detecting/determining 103 beat frequencies for each received signal in said sweep pair. The method further comprises the step of determining 104 a velocity and range of said at least one object. The determining 104 may be performed by solving a linear equation system for velocity and range from the beat frequencies of the first and second wave form 104 of said at least one object. This may be performed by signal processing.

If the obtained signals are reflected from a single object, the step of determining comprises linearly combining al, beat frequencies of the obtained first and second signals of the sweep pair so to derive the velocity and range of said single object. The deriving may be performed by the equation system or any other suitable type of computing.

Accordingly, if said obtained signals are reflected from a plurality of objects, the step of determining comprises linearly combining b1 the beat frequencies obtained from the signals to derive a plurality of possible associations, wherein for P targets, the associations are P², P being an integer >1, each association being indicative of a possible target. Thereafter, the method comprises transmitting b2 a sequence of further sweep pairs and identifying b3 correct associations based on said sequence. Accordingly, the possible associations are not necessarily correct associations. Consequently, the method derives the correct associations based on the derived possible associations.

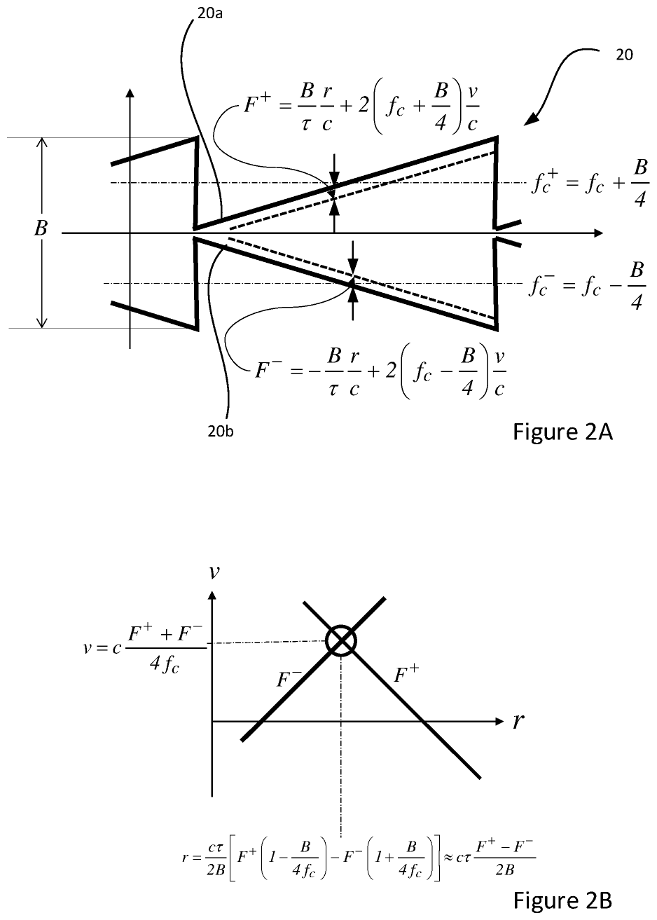

FIG. 2A illustrates a sweep pair 20 with frequency along the vertical axis and time along the horizontal. The sweep pair comprises a first and a second electromagnetic waveform 20a, 20b being counter directed. As in FIG. 2A, the first waveform 20a may be an up-chirp and the second waveform 20b may be a down-chirp. The value B is the radar bandwidth. The values F⁺ and F⁻ are the beat frequencies of the respective chirps 20a, 20b.

Accordingly, the beat frequencies refer to the differences in frequency between an echo and a transmitted up- and down-chirp. In some aspects, centre frequency

$${f}_{c}^{+} , {f}_{c}^{-}$$

can be in the interval 50-90 GHz, said pre-determined sweep time can be 2-3 milliseconds, preferably, 2.25-2.75 milliseconds, more preferably 2.5 milliseconds. As illustrated in FIG. 2A, each first electromagnetic waveform 20a is in a first frequency channel, and each second electromagnetic waveform 20b is in a second frequency channel. The first and the second frequency channels preferably are adjacent each other.

FIG. 2A further illustrates how the beat frequencies F⁺ and F⁻ arises as two different linear combinations of target range and speed.

FIG. 2B illustrates, in accordance with method step al in FIG. 1, how range r and velocity v may be calculated as a solution to a linear equation system posed by the linear combination giving rise to the beat frequencies F⁺ and F⁻ in FIG. 2A.

In accordance with this calculation example, based on said linear equation system, the range and velocity resolution becomes determined. The implied range and velocity resolution follows from the formulas as disclosed in FIG. 2B, combined with the attainable resolution for the beat frequencies, as

$$Δ {F}^{\pm } = \frac{1}{τ} ⇒ \{ \begin{matrix}Δ v = \frac{c}{4 {f}_{c}} \frac{\sqrt{2}}{τ} = \frac{c}{2 \sqrt{2} {f}_{c} τ} = 0.15 m / s \\ Δ r = \frac{c τ}{2 B} \frac{\sqrt{2}}{τ} = \frac{c}{\sqrt{2} B} = 0.2 m\end{matrix} \qquad ( 3 )$$

It should be noted that the values 0.15 m/s and 0.2 m, are merely exemplary values for exemplifying a calculation in accordance with some aspects of the method 100 herein.

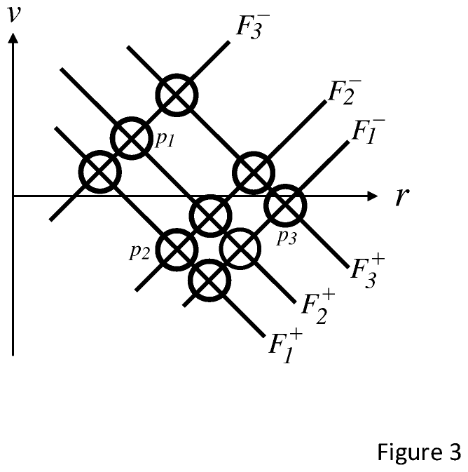

FIG. 3 illustrates when signals are reflected off a plurality of objects and beat frequencies are linearly combined so to derive a plurality of possible associations. FIG. 3 illustrates three targets,1,2,3 Use the notation

$${F}_{n ( i )}^{+} , {F}_{m ( i )}^{-}$$

to include the maps i→n(i),m(i)tying particular first or second band beat frequencies to a particular target (the target given by its velocity and speed rᵢ, vᵢ). Thus in FIG. 3

$${F}_{1}^{+} = {F}_{n ( 2 )}^{+} , {F}_{2}^{+} = {F}_{n ( 1 )}^{+} , , {F}_{3}^{+} = {F}_{n ( 3 )}^{+} , {F}_{1}^{-} = {F}_{m ( 3 )}^{-} , {F}_{2}^{-} = {F}_{m ( 2 )}^{-} , , {F}_{3}^{-} = {F}_{m ( 1 )}^{-} ,$$

reflecting that the proper associations are

$${F}_{1}^{+} ↔ {F}_{2}^{-} {F}_{2}^{+} ↔ {F}_{3}^{-} {F}_{1}^{+} , ↔ {F}_{1}^{-} .$$

The sequel details how method 100 utilizes, as disclosed in FIG. 1, repeated sweeps to find these correct associations.

In the process of performing repeated sweeps the beat frequencies will change due to range changing from sweep to sweep, caused by the target velocity as described by the formulas

$$\begin{matrix}{F}_{{n}^{ℓ} ( i )}^{+ \vert ℓ} = - B \frac{{r}_{i} + ℓ {v}_{i} τ}{c τ} + 2 ( {f}_{c} + \frac{B}{4} ) \frac{{v}_{i}}{c} \\ {F}_{{m}^{ℓ} ( i )}^{- \vert ℓ} = B \frac{{r}_{i} + ℓ {v}_{i} τ}{c τ} + 2 ( {f}_{c} - \frac{B}{4} ) \frac{{v}_{i}}{c}\end{matrix} \qquad ( 4 )$$

Here [symbol] =0,1, . . . is sweep number. Further rᵢ, vᵢ appear as motion constants with rᵢ being target range at the time for the [symbol] =0 sweep. Moreover [symbol] , [symbol] are beat frequency indices tracked to pertain to a steady rate of beat frequency change between sweeps (implying that index number will swop if a beat frequency development results in two beat frequencies cross each other as [symbol] progresses).

Without knowledge of the maps i→n(i),m(i) any of the associations depicted as beat frequency line intersections in FIG. 3 represents a possible target, which thereby becomes given by range and velocity values

$${r}_{{m}^{ℓ} ( i ) {n}^{ℓ} ( j )}^{ℓ} , {v}_{{m}^{ℓ} ( i ) {n}^{ℓ} ( j )}^{ℓ}$$

according to

$${v}_{{m}^{ℓ} {n}^{ℓ}}^{ℓ} = \frac{c}{{f}_{c}} \frac{{F}_{{m}^{ℓ}}^{- \vert ℓ} + {F}_{{n}^{ℓ}}^{+ \vert ℓ}}{4} {r}_{{m}^{ℓ} {n}^{ℓ}}^{ℓ} = \frac{c τ}{2 B} [ {F}_{{m}^{ℓ}}^{- \vert ℓ} ( 1 + \frac{B}{4 {f}_{c}} ) - {F}_{n}^{+ \vert ℓ} ( 1 - \frac{B}{4 {f}_{c}} ) ] \qquad ( 5 )$$

From (4) the formulas can be re-expressed in target range and velocity parameters rᵢ, vᵢ as

$${v}_{{m}^{′} ( i ) {n}^{′} ( j )}^{ℓ} = \frac{{v}_{j} + {v}_{i}}{2} + \frac{B}{4 {f}_{c}} \frac{1}{τ} ( {r}_{j} - {r}_{i} ) + \frac{B}{4 {f}_{c}} ( ℓ + \frac{1}{2} ) ( {v}_{j} - {v}_{i} ) {r}_{{m}^{ℓ} ( i ) {n}^{ℓ} ( i )}^{ℓ} = \frac{{r}_{j} + {r}_{i}}{2} + τ \frac{{f}_{c}}{B} ( {v}_{j} - {v}_{i} ) - \frac{B}{4 {f}_{c}} ( ℓ - \frac{1}{2} ) [ {r}_{j} - {r}_{i} + ( ℓ - \frac{1}{2} ) τ ( {v}_{j} - {v}_{i} ) ] \qquad ( 6 )$$

Evidently the correct associations are where i=j which implies

$${r}_{{m}^{ℓ} ( i ) {n}^{ℓ} ( i )}^{ℓ} = {r}_{i} , {v}_{{m}^{ℓ} ( i ) {n}^{ℓ} ( i )}^{ℓ} = {v}_{i} .$$

In particular and most importantly

$${r}_{{m}^{ℓ} {n}^{ℓ}}^{ℓ} , {v}_{{m}^{ℓ} {n}^{ℓ}}^{ℓ}$$

remains constant from sweep to sweep whereas for a false association they change from sweep to sweep by the values rⱼ−rᵢ, vⱼ−vᵢ determined by the range and velocity separation of the targets falsely associated.

With the non-constancy of

$${r}_{{m}^{ℓ} {n}^{ℓ}}^{ℓ} , {v}_{{m}^{ℓ} {n}^{ℓ}}^{ℓ}$$

from sweep to sweep being a sufficient condition for false associations, signal processing methods for rejecting false alarms will be based on this property. The invention encompasses in accordance with FIGS. 1 and 100 any signal processing method removing false alarms by utilizing the non-constancy of

$${r}_{{m}^{ℓ} {n}^{ℓ}}^{ℓ} , {v}_{{m}^{ℓ} {n}^{ℓ}}^{ℓ}$$

in the process of repeated sweeps, as detailed in Formula (6).

A particularly useful way of utilizing the non-constancy of

$${r}_{{m}^{ℓ} {n}^{ℓ}}^{ℓ}$$

is by calculating, by signal processing, a difference between range values obtained from associations in a sweep pair sequence counted in positive time direction and corresponding associations in a sweep pair sequence counted in negative time direction from an arbitrarily selected zero time, i.e. forming quantity

$${ρ}_{m ( i ) n ( j )}^{ℓ} = \frac{{r}_{m ( i ) n ( j )}^{ℓ + 1} - {r}_{m ( i ) n ( j )}^{- ℓ}}{2} = ( ℓ + \frac{1}{2} ) \frac{B}{4 {f}_{c}} ( {r}_{i} - {r}_{j} ) \qquad ( 7 )$$

Further, the step comprises rejecting amongst said associations, associations for which these range differences progress from zero at a linear non-zero rate, which is/being indicative of all false associations, and can be effectively established adopting well-known signal processing techniques (e.g. linear least square and linear regression techniques).

It should be noted that the equations (4-7), and their use may be varied within the scope of the present disclosure. Thus, the present disclosure is not limited to the specific set or form of equations as specified herein.

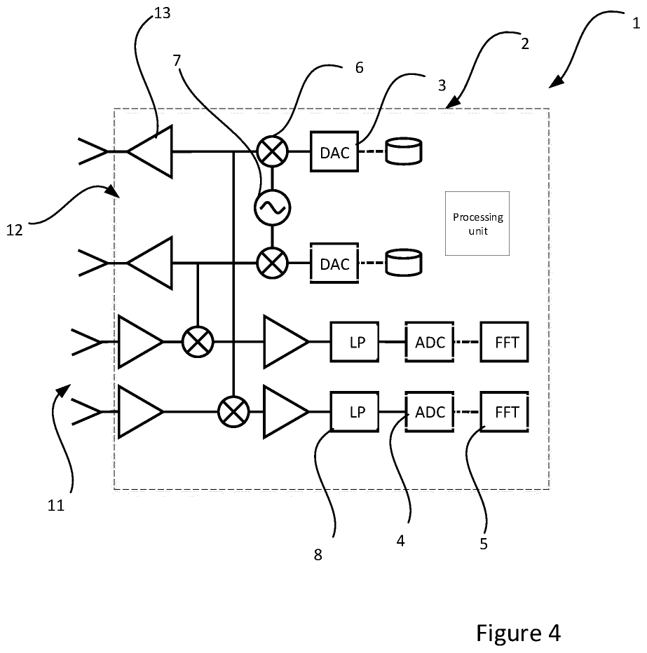

FIG. 4 schematically illustrates an electronic device 1, e.g., a radar device in accordance with some aspects configured to perform the method in accordance with any aspect herein. The electronic device 1 comprises control circuitry 2 for performing the method 100 herein. The control circuitry 2 may comprise signal processing modules such as digital-to-analog conversion modules (DAC) 3, analog to digital conversion modules ADC 4, Fast Fourier transform modules 5 (FFT), mixers 6, an oscillator 7, filter units 8 (e.g. a low, high or bandpass filters). Further, the device 1 comprises a receiving and a transmitting antenna 11, 12. Each antenna may comprise antenna elements, amplifiers 13 and any other suitable circuitry of an antenna. The device 1 will also comprise the required signal processing resources either as an integral part of 2 (as shown) or as a separate unit outside 2.

The control circuitry/electronic device 1, 2 further comprise/is connected to suitable memory resources, an input/output interface (not shown) and optionally at least one communication interface.

The memory resources may comprise any form of volatile or non-volatile computer accessible memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used.

The control circuitry 2 may be arranged to run instruction sets in the memory device for operating the method herein. The electronic device 1 may further comprise a processing unit, e.g. a microprocessor, digital signal processor (DSP), ASIC (Application Specific Integrated Circuit), FPGA (Field Programmable Gate Array), or a combination of these, or other similar processing means arranged to run instruction sets, these components may be integral with or connected to the control circuitry 2. The computer readable storage medium may be of non-volatile and/or volatile type and transitory or non-transitory type; for instance RAM, EEPROM, flash disk and so on.

The communication interface may be of any suitable type such as Ethernet, SPI bus, I2C bus, RS232, CAN bus, wireless communication technology, or other communication protocols depending on application. Furthermore, the communication interface may be used to communicate results, messages, status reports and similar to external devices and control units, for example, to a user interface/control system of a vehicle.

Memory resources may be used to store computer programs for signal processing, transmit waveforms, calibration data, intermediate results in the signal processing stages.

The control circuitry 2 and/or the electronic device 1 may include, for example, one or more central processing units (CPUs), gate arrays (FPGAs), graphics processing units (GPUs) dedicated to performing calculations, and/or other processing devices. Calculations may comprise e.g. signal processing calculations e.g. for determining beat frequencies, resolving range and velocity, and rejecting false association utilizing any suitable form of calculation for performing the method according to any aspect herein. The memory device may comprise one or more computer-readable media and can store information accessible by the control circuitry 2, including instructions/programs e.g. instruction for performing a method.

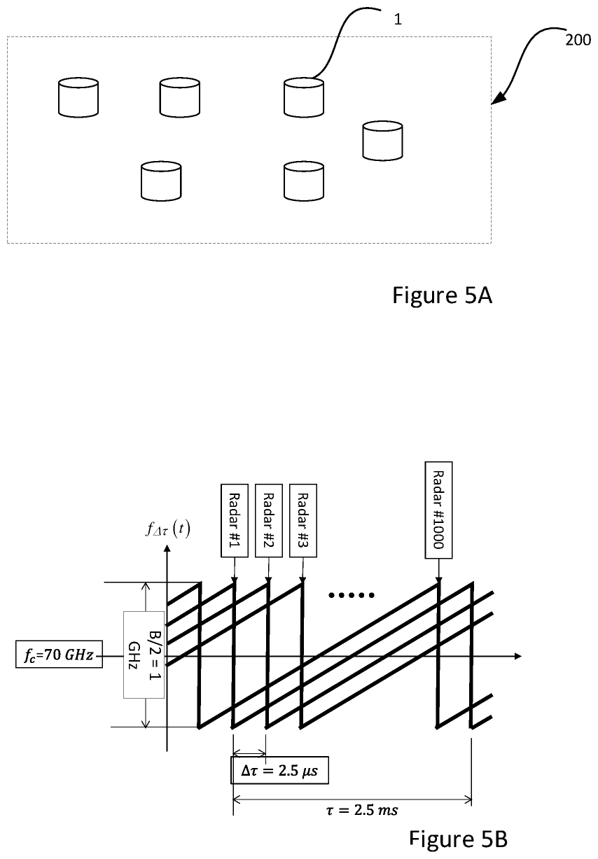

FIG. 5A schematically illustrates a system 200 providing mutual interference suppression, comprising a plurality of similar electronic devices 2, performing the method 100 according to any one of the claims 1-6, wherein each electronic device 1 utilizes/is configured to utilize/is assigned one of a plurality transmission channels for transmitting said counter directed chirps, wherein adjacent channels of said plurality transmission channels have a time delay relative each other. Each channel is assignable to a single electronic device 1 allowing the device 1 to transmit said sweep pair.

FIG. 5B illustrates the arrangement of waveforms in either of the two channel in a plot allocated to 1000 electronic devices in accordance with an exemplary system 200 which only shows up-chirps. In FIG. 5B, the total bandwidth B is 1 GHz, whereas the bandwidth of either channels is half this value Moreover, there can be up to 1000 electronic devices utilizing the same band. Moreover, each electronic device 1 operates in a channel separated by a time-span of 2.5 μs to the neighboring channels. The disclosure is not limited to 2,5 μs which is merely an exemplary separation of channels. Thus, the total time window is in the example 2.5 ms, which is the repetition rate of the radar signal

The voltage leakage between adjacent channels is theoretically for the adopted linear chirp signals

$${κ}_{Δ τ} = \frac{1}{π B} ( \frac{1}{Δ τ} + \frac{1}{τ - Δτ} ) \vert sin \frac{π B Δτ ( τ - Δτ )}{τ} \vert \qquad ( 5 )$$

While the exemplary numbers given in FIG. 5 are adapted to typical car radar requirements, different applications provide different requirements on the level of suppression required for maintaining the radar function. These requirements depend on factors such as radar antenna properties, intended, surveillance and interferer range and the radar cross section of objects to be detected. It is observed that according to (5) leakage between adjacent channels essentially equals the exploited number of channels divided by the time-bandwidth product 2B of the radar. It can be demonstrated that the accumulated interference of channels further off can be neglected in comparison with the adjacent channel impact.

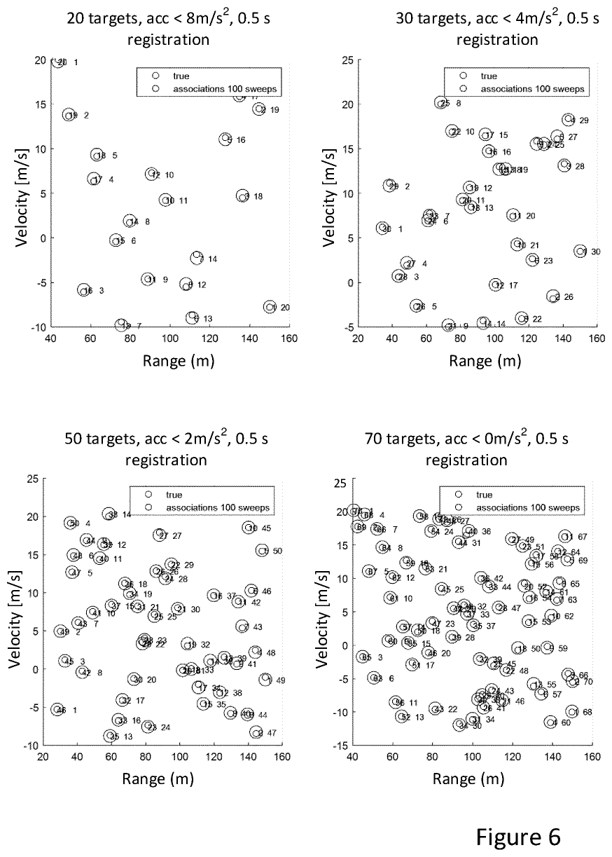

FIG. 6 illustrates the performance of the method as disclosed herein after simulations thereof. The purpose of the disclosure of FIG. 6 is to further describe the disclosure as presented herein accompanied with advantages thereof. It should be noted that the performance is based on embodiments for a disclosing purpose, however it is not limited to said embodiments and may be varied within the present disclosure.

FIG. 6 illustrates in the form of four plots capacity to association of multiple targets (having accelerations) without any errors as randomly distributed accelerations are imposed on the targets. FIG. 6 discloses the method 100 herein performed on 20, 30, 50 and 70 objects respectively and illustrates the accuracy of the velocity and range resolving of said objects.

1. A method for resolving range and velocity from at least one object, the method comprising:
transmitting, simultaneously, a first and a second electromagnetic waveform, each comprising a frequency modulated chirp having a pre-determined sweep time, the first and second electromagnetic waveforms being counter directed chirps forming a sweep pair;
obtaining, independently, a first and a second time domain signal formed by reflections of said first and second electromagnetic waveforms of said sweep pair;
determining a beat frequency for a baseband signal of each obtained time-domain signal in said sweep pair; and
determining a velocity and a range of said at least one object, wherein, if said obtained signals are reflected from a single object, said determining of the velocity comprises;
linearly combining, beat frequencies of the obtained first and second signals of the sweep pair so to derive the velocity and range of said single object,
wherein if said obtained signals are reflected from a plurality of objects, said determining of the velocity comprises:
linearly combining the beat frequencies obtained from the signals to derive a plurality of possible associations, wherein for P targets, the associations are P², P being an integer >0, each association being indicative of a possible target;
transmitting (b2) a sequence of further sweep pairs; and
identifying (b3) correct associations based on said sequence.

2. The method according to claim 1, wherein, at a center frequency of 50-90 GHz, said pre-determined sweep time is 2-3 milliseconds.

3. The method according to claim 1, wherein each first electromagnetic waveform is in a first frequency channel, and each second electromagnetic waveform is in a second frequency channel, wherein the first and the second frequency channel are adjacent each other.

4. The method according to claim 1, wherein said identifying further comprises:
calculating, by signal processing, a difference between range values obtained from associations in a sweep pair sequence counted in positive time direction and corresponding associations in a sweep pair sequence counted in negative time direction from an arbitrarily selected zero time; and
rejecting amongst said associations, associations for which the range difference progress from zero at a linear non-zero rate, which is indicative of all false associations.

5. The method according to claim 4, wherein calculating by signal processing comprises:
obtaining candidate range values obtained from any pairing of upper and lower band tracked beat frequencies
$${F}_{m ( ℓ )}^{ℓ -} , {F}_{n ( ℓ )}^{ℓ +} ; m ( ℓ ) , n ( ℓ ) = 1 , 2 , …$$
and utilizing a first equation:
$${r}_{n ( ℓ ) m ( ℓ )}^{ℓ} = \frac{c τ}{2 B} [ {F}_{m ( ℓ )}^{ℓ -} ( 1 + \frac{B}{4 {f}_{c}} ) - {F}_{n ( ℓ )}^{ℓ +} ( 1 - \frac{B}{4 {f}_{c}} ) ] ,$$
and, subsequent to said first equation, utilizing a second equation:
$${ρ}_{n ( ℓ ) m ( ℓ )}^{ℓ} = {r}_{n ( ℓ + 1 ) m ( ℓ + 1 )}^{ℓ + 1} - {r}_{n ( ℓ ) m ( ℓ )}^{- ℓ}$$
wherein [symbol] = . . . −2,−1,0,1,2, . . . being sweep number.

6. The method according to claim 1, wherein the chirps are linear chirps.

7. A computer-readable storage medium storing one or more programs configured to be executed by one or more control circuitry of an electronic device, the one or more programs including instructions for performing the method of claim 1.

8. An electronic device having control circuitry therein configured to perform the method according to claim 1.

9. A fixed installation or a vehicle comprising an electronic device having control circuitry therein configured to perform the method according to claim 1.

10. A system comprising a plurality of electronic devices performing the method according to claim 1, wherein each electronic device is configured to utilize one of a plurality transmission channels for transmitting said counter directed chirps, wherein adjacent channels of said plurality transmission channels have a time delay relative each other.

11. The method according to claim 1, wherein, at a center frequency of 50-90 GHz, said pre-determined sweep time is 2.25-2.75 milliseconds.

12. The method according to claim 1, wherein, at a center frequency of 50-90 GHz, said pre-determined sweep time is 2.5 milliseconds.
